(19) United States
(12) Patent Application Publication
(10) Pub. No.: US 2026/0087662 A1
(43) Pub. Date: Mar. 26, 2026

(54) MOVED OBJECT DISPLAYING SYSTEM AND MOVED OBJECT DETECTING METHOD

(71) Applicant: NTN CORPORATION, Osaka (JP)

(72) Inventor: Shota SUZUKI, Shizuoka (JP)

(21) Appl. No.: 19/320,379

(22) Filed: Sep. 5, 2025

(30) Foreign Application Priority Data
Sep. 26, 2024 (JP) 2024-167582

(51) Int. Cl. G06T 7/70; G06T 5/50

(52) U.S. Cl. CPC G06T 7/70; G06T 5/50

(57) ABSTRACT

Provided is a moved object displaying system configured to efficiently detect an object that has moved. A moved object displaying system (1) includes: a camera (3); a control unit (11) ; and a display unit (5). The camera (3) is configured to take a before image comprising a plurality of objects, and an after image taken after the before image, from the same direction. The control unit (11) is configured to display, on the display unit (5), a difference between the before image and the after image by a heat map.

### TECHNICAL FIELD

The present invention relates to a moved object displaying system and a moved object detecting method.

### BACKGROUND ART

At the time of a picking operation or the like, objects loaded in a container or the like may be shifted to cause scratches on the object. For example, a bearing (object) before heat treatment is easily scratched, and hence, when load shifting has occurred, it has been required to find a scratched bearing to sort out the scratched bearing as a defective product.

For example, in Japanese Patent Application Laid-open No. 2007-179301, there is disclosed a detecting method of detecting load shifting of cuboid-shaped articles stacked on a palette. In Japanese Patent Application Laid-open No. 2007-179301, load shifting of the articles is detected by taking images before and after transfer of the articles onto the palette from above to calculate a degree of change in the images, or sensing an upper surface shape of the articles on the palette by a three-dimensional measuring part to estimate the overall shape of a group of articles.

### SUMMARY OF INVENTION

### Technical Problem

When the objects are regularly arranged as in Japanese Patent Application Laid-open No. 2007-179301, as long as whether or not load shifting has occurred can be sensed by a system, it is easy for an operator to identify the object that has moved by load shifting. However, for example, when bearings that are objects are loaded in bulk in the container, even when the system has been able to recognize that the load shifting had occurred, it has been difficult for the operator to recognize which bearing has moved by the load shifting.

The present invention has been made in view of the above-mentioned circumstances, and has an object to efficiently detect an object that has moved.

### Solution to Problem

In order to solve the above-mentioned problem, according to at least one embodiment of the present invention, there is provided a moved object displaying system, comprising: an imaging mechanism; a control unit; and a display unit. The imaging mechanism is configured to take a before image comprising a plurality of objects, and an after image taken after the before image, from the same direction. The control unit is configured to display, on the display unit, a difference between the before image and the after image by a heat map.

With the above-mentioned configuration, the heat map can display the changed part in a different color. Thus, the operator can check the heat map to immediately grasp the position of the object that has been displaced, and hence the object that has moved can be efficiently detected in a short period of time.

The control unit may be configured to: create a superimposed image in which the heat map is superimposed with one of the after image or an image taken by the imaging mechanism from the same direction as the after image; and display the superimposed image on the display unit. With the heat map and the taken image being superimposed, in which area a part colored dark in the heat map is positioned in an actual space can be more easily grasped visually. Thus, the object that has moved can be more efficiently detected in a short period of time.

Further, according to at least one embodiment of the present invention, there is provided a moved object displaying system, comprising: a sensing mechanism; a control unit; and a display unit. The sensing mechanism is configured to sense positions of a plurality of objects at different timings, and the control unit is configured to display, based on sensing results obtained by the sensing mechanism, a displacement amount of the plurality of objects by a heat map. The heat map can also be created based on the position sensing results of the object obtained by the sensing mechanism. In this manner, similarly to the above-mentioned configuration, the object that has moved can be efficiently detected in a short period of time.

Further, according to at least one embodiment of the present invention, there is provided a moved object detecting method, comprising: an imaging step of taking a before image comprising a plurality of objects, and an after image taken after the before image, from the same direction; a display step of displaying a difference between the before image and the after image by a heat map; and a detection step of detecting, through use of the heat map, one of the plurality of objects that has moved between a time of taking the before image and a time of taking the after image.

### Advantageous Effects of Invention

According to at least one embodiment of the present invention, it is possible to efficiently detect an object that has moved.

### BRIEF DESCRIPTION OF DRAWINGS

FIG. 1 is a schematic side view for illustrating a configuration of a moved object displaying system according to one embodiment of the present invention.

FIG. 2 is a schematic view for illustrating a before image before picking, which is an image obtained by photographing an inside of a container by a camera.

FIG. 3 is a schematic view for illustrating an after image after the picking, which is an image obtained by photographing the inside of the container by the camera.

FIG. 4 is a schematic view for showing an example of a heat map.

FIG. 5 is a schematic view for showing an example of a superimposed image.

FIG. 6 is an explanatory flow chart for illustrating a procedure of a moved object detecting method of detecting a moved object through use of the moved object displaying system.

### DESCRIPTION OF EMBODIMENTS

Now, an embodiment of the present invention is described with reference to the drawings. Throughout the drawings, the same or corresponding parts are denoted by the same reference symbols, and redundant description thereof is simplified or omitted as appropriate.

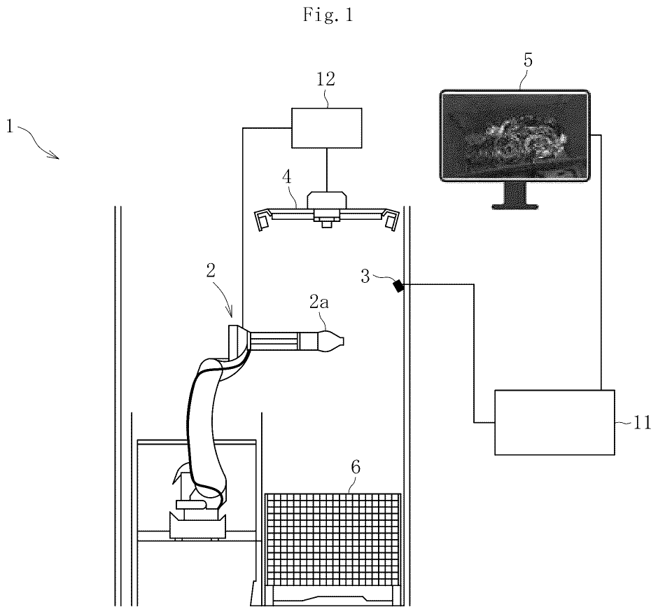

FIG. 1 is a schematic side view for illustrating a configuration of a moved object displaying system 1 according to one embodiment of the present invention.

As illustrated in FIG. 1, the moved object displaying system 1 comprises a robot arm 2, a camera 3 serving as an imaging mechanism, a gripping position detection camera 4, a display unit 5, a control unit 11, a gripping position calculation control unit 12, and the like.

The robot arm 2 comprises a gripping arm 2a configured to grip a bearing being an object. The robot arm 2 is an industrial robot, and can arrange the gripping arm 2a to a desired position to grip the bearing or release the gripped bearing.

Bearings before heat treatment which have been conveyed from a previous process are loaded in bulk a container 6. Further, the bearing in the container 6 is picked by the robot arm 2 to be conveyed to a subsequent process.

The gripping position detection camera 4 is provided vertically above the container 6. The gripping position detection camera 4 is formed of a plurality of three-dimensional sensors, and detects a position of the bearing in the container 6 to be gripped by the gripping arm 2a.

The camera 3 takes an image of the container 6 and the bearings loaded in bulk in the container 6, from diagonally above. The camera 3 may be configured to take an image from vertically above of the container 6 when there are no problems of, for example, resolution of the taken image and detection by the gripping position detection camera 4. The camera 3 in this embodiment is a two-dimensional camera.

The gripping position calculation control unit 12 controls the robot arm 2 based on the detection results obtained by the gripping position detection camera 4, to move the gripping arm 2a to a desired position, and cause the gripping arm 2a to carry out a picking operation for the bearing.

The control unit 11 carries out, based on the images taken by the camera 3, control for detecting the moved object, such as displaying a superimposed image on the display unit 5 (details are described later). The display unit 5 in this embodiment is a display.

In a process of manufacturing a bearing as described above, the bearings loaded in bulk in the container 6 may be shifted around the time of picking, and the fallen bearing or the bearing that has collided with the fallen bearing may be scratched. However, it is difficult to identify the bearing that has moved by the load shifting from among the bearings arranged at random in the container 6. In particular, when the object is a bearing, whether the bearing has been scratched cannot be recognized unless the inner ring or the outer ring thereof is circumferentially checked, and it also takes time for determination on whether the bearing has been scratched.

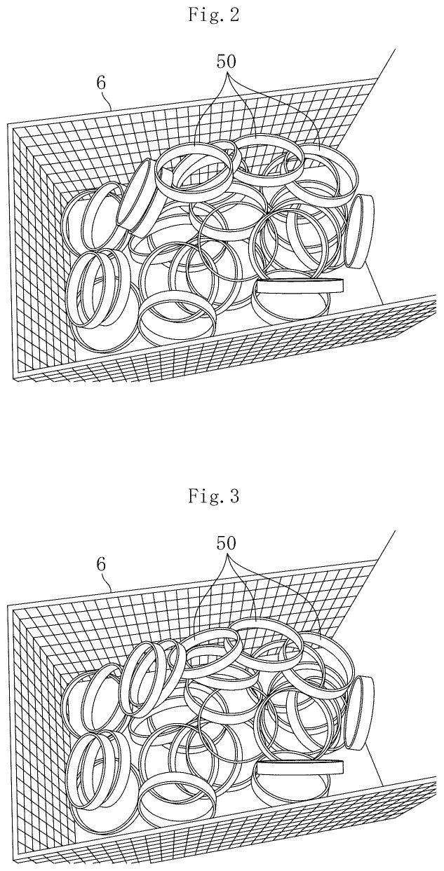

Next, a moved object detecting method using the moved object displaying system 1 of this embodiment is described with reference to FIG. 2 to FIG. 5.

FIG. 2 schematically shows a before image which is an example of an image obtained by photographing the inside of the container 6 by the camera 3. As illustrated in FIG. 2, a plurality of bearings 50 are loaded in bulk in the container 6. The before image in this embodiment is an image taken before the picking operation. Further, an after image which is an image obtained by photographing the inside of the container 6 by the camera 3 after the bearing 50 is picked from FIG. 2 is schematically illustrated in FIG. 3. Those before image and after image are images taken from the same direction by the fixed camera 3.

In this embodiment, the before image of FIG. 2 and the after image of FIG. 3 are subjected to image processing by the control unit so that difference data and a difference image of before and after are created. Then, the generated difference image is displayed on the display unit as a heat map. As described above, the control unit comprises an image processing device configured to process the before image and the after image to create a difference image and a heat map.

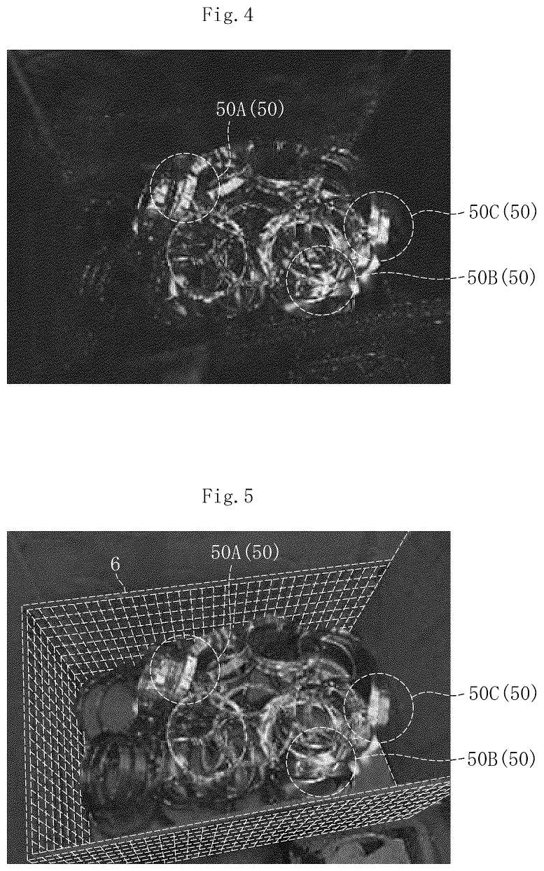

FIG. 4 schematically shows an example of the heat map displayed as described above, and is a heat map created from the before image of FIG. 2 and the after image of FIG. 3. This heat map is an image obtained by evaluating pixels at respective positions of the before image and the after image by shades of colors of the pixels, and displaying pixels colored in respective levels based on the difference between the before image and the after image. That is, pixels having large changes in shades of the colors are expressed in stages by warm colors, and pixels having small changes or no change are expressed in stages by cool colors. The warm colors and the cool colors are merely examples, and the pixels are only required to be distinguishable visually, such as expressing the pixels with shades of a single color. In an actual image, parts of bearings 50A, 50B, and 50C shown in FIG. 4 are expressed by warm colors, and it is understood that those bearings 50 have been moved around the time of picking. Bearings 50 other than the bearings 50 that have moved are also displayed with colors, and are displayed with cool colors lighter than the colors of the bearings 50A to 50C. The reason why those bearings 50 are colored in the heat map is, for example, errors of the camera 3 and the control unit 11 due to disturbance or the like, and a difference in how the light hits the bearing 50 at the time of taking the before image and the after image.

When the difference between the before image and the after image is displayed by the heat map as in FIG. 4, which part has been changed can be visually recognized instantly. Thus, when the load shifting has occurred, the operator can check the heat map to immediately identify the bearing 50 that has moved by the load shifting. Accordingly, the defective product can be easily sorted out by checking the presence or absence of scratches in the bearing 50 that has moved or the bearing 50 present around the bearing 50 that has moved. Thus, the work efficiency of sorting out the defective product is improved, and hence the burden of the operator is reduced.

Further, as illustrated in FIG. 5, a superimposed image obtained by superimposing the heat map and the taken image may be created and displayed on the display unit. In the case of an image displaying only the difference as in FIG. 4, it may be difficult to discriminate which bearing in the container 6 the bearing 50 colored dark in the image actually corresponds to, due to reasons such as a small number of portions with changes. However, when the heat map and the taken image are superimposed as in FIG. 5, in which area in the container 6 the bearing 50 displayed as a difference is positioned can be easily grasped, and the bearing 50 that has moved in the container 6 can be more easily identified. The image to be superimposed with the heat map may be the after image used for creating the heat map, or may be a present image when the camera 3 continues to take images in real time. Further, the image to be superimposed can also be other images taken by the camera 3 from the same direction. In FIG. 5, for the sake of convenience, the container 6 is indicated by the dotted line.

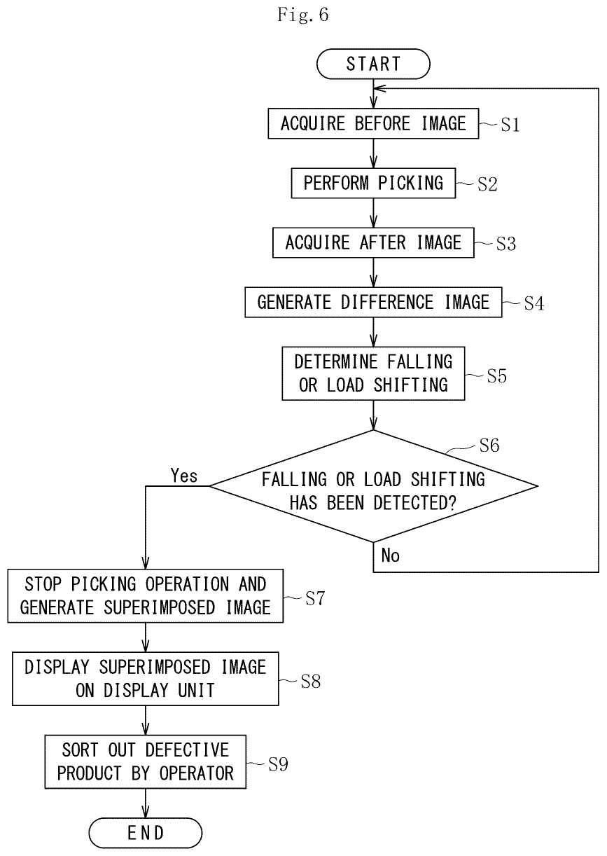

Next, with reference to the flow chart of FIG. 6, a procedure of a moved object detecting method of detecting a moved object through use of the moved object displaying system of this embodiment is described.

As illustrated in FIG. 6, first, the camera 3 takes the before image before the picking operation is performed, and the control unit 11 acquires the before image (Step S1). Then, the robot arm 2 picks the bearing 50 in the container 6 (Step S2).

After the picking, the camera 3 takes the after image, and the control unit 11 acquires the after image (Step S3). Then, the control unit 11 creates the difference data and the difference image from the before image and the after image (Step S4), and determines whether or not falling or load shifting has occurred from the difference data (Step S5). Step S1 and Step S3 are an imaging step performed by the camera 3.

When a change amount of the difference data exceeds a threshold value of the change amount set in advance, it is determined that falling or load shifting has occurred. This determination based on the change amount and the threshold value may determine that the falling or load shifting has occurred when a change amount of any one pixel in the difference data exceeds the threshold value, or may determine that the falling or load shifting has occurred when there are a predetermined number or more of pixels exceeding the threshold value. As another example, it may be determined that the falling or load shifting has occurred when there are a predetermined number or more of pixels having change amounts exceeding the threshold value, within a predetermined close range in the taken image.

When it is determined that the falling or load shifting has occurred, the picking operation is stopped, and the control unit 11 creates a heat map from the difference image described above. Then, the control unit 11 superimposes this heat map with the present image taken by the camera 3 to generate a superimposed image (Step S7).

The control unit 11 displays the superimposed image on the display unit 5 (display step of Step S8). The operator checks the bearing 50 based on this superimposed image, and detects the scratched bearing 50 as described above (detection step of Step S9).

Meanwhile, when it is determined that no load shifting or falling has occurred in Step S6, the procedure of Step S1 to Step S5 described above is repeated for each picking operation.

Description has been given above of the case in which the imaging mechanism takes the before image and the after image to create the heat map, but the present invention is not limited thereto. A sensing mechanism configured to sense a position of an object may be used in place of the imaging mechanism. Examples of the sensing mechanism that can be used comprise a laser sensor, an ultrasonic sensor, and a millimeter wave radar sensor. In this case, a plurality of sensing mechanisms are arranged (for example, in matrix). A distance from the sensing mechanism to the object or the container at each position is detected around the time of picking, and a change amount of the distance is calculated. Then, a displacement amount in the vertical direction at each position in a predetermined plane is expressed by a heat map, and thus the heat map can be displayed on the display unit. This plane may be, for example, a surface parallel with a placing surface for the bearing 50 of the container 6, or may be a plane or the like in which the container 6 is viewed from diagonally above as in FIG. 2, FIG. 3, and the like.

Further, a three-dimensional camera may be used as the sensing mechanism. In this case, similarly to the above-mentioned imaging mechanism, the displacement amount in the vertical direction at each position in a predetermined plane is expressed by a heat map, and the heat map can be displayed on the display unit. Further, a three-dimensional camera can be used as the imaging mechanism to take the before image and the after image that have been described above, and create the difference data (difference image) and the heat map. In this case, the falling or load shifting may be determined based on the displacement amount in the vertical direction of this image in addition to the difference data between the before image and the after image. For example, it can also be determined that the falling or load shifting has occurred when any one of the difference data between the before image and the after image or the displacement amount in the vertical direction exceeds a threshold value. Further, it may be determined that the falling or load shifting has occurred by calculating a change amount through use of 3D point cloud data obtained by the three-dimensional camera.

Description has been given above of the embodiment in which whether or not the falling or load shifting has occurred is determined by one camera 3, but the determination may be made through use of a plurality of imaging mechanisms having different imaging directions. For example, the moved object displaying system 1 comprises three cameras 3 having different imaging directions. The before image and the after image are taken by each 41 the cameras 3, and the control unit creates the difference data and the difference image. Then, it may be determined that the falling or load shifting has occurred when any one of those three pieces of difference data exceeds the threshold value. In this manner, overlooking of the falling or load shifting can be prevented, and hence the quality of the bearing can be improved. Meanwhile, for example, it can be determined that the falling or load shifting has occurred when two or more pieces of difference data exceed the threshold value. In this manner, the accuracy of determination of the falling and load shifting can be enhanced.

The embodiment of the present invention has been described above, but the present invention is not limited to the above-mentioned embodiment, and it is needless to say s that various modifications can be made without departing from the gist of the present invention.

In the above-mentioned embodiment, the bearing has been described as the object, but the object is not limited to the bearing in the present invention. Further, in the above-mentioned embodiment, the picking operation is performed around the time of taking the before image and the after image, but the present invention is not limited thereto. That is, the moved object can be displayed and detected by taking the before image and the after image around the time of an operation that may cause the object to move.

### REFERENCE SIGNS LIST

1 moved object displaying system
3 camera (imaging mechanism)
5 display unit
6 container
11 control unit
12 gripping position calculation control unit
50 bearing (object)

1. A moved object displaying system, comprising:
an imaging mechanism;
a control unit; and
a display unit,
wherein the imaging mechanism is configured to take a before image comprising a plurality of objects, and an after image taken after the before image, from the same direction, and
wherein the control unit is configured to display, on the display unit, a difference between the before image and the after image by a heat map.

2. The moved object displaying system according to claim 1, wherein the control unit is configured to: create a superimposed image in which the heat map is superimposed with one of the after image or an image taken by the imaging mechanism from the same direction as in the after image; and display the superimposed image on the display unit.

3. A moved object displaying system, comprising:
a sensing mechanism;
a control unit; and
a display unit,
wherein the sensing mechanism is configured to sense positions of a plurality of objects at different timings, and
wherein the control unit is configured to display, based on sensing results obtained by the sensing mechanism, a displacement amount of the plurality of objects by a heat map.

4. A moved object detecting method, comprising:
an imaging step of taking a before image comprising a plurality of objects, and an after image taken after the before image, from the same direction;
a display step of displaying a difference between the before image and the after image by a heat map; and
a detection step of detecting, through use of the heat map, one of the plurality of objects that has moved between a time of taking the before image and a time of taking the after image.
